(19) United States
(12) Patent Application Publication
(10) Pub. No.: US 2016/0321325 A1
(43) Pub. Date: Nov. 3, 2016

(54) METHOD, DEVICE, AND STORAGE MEDIUM FOR ADAPTIVE INFORMATION

(71) Applicant: Xiaomi Inc., Beijing (CN)

(72) Inventors: Xingchao Wang, Beijing (CN); Yanhuan Peng, Beijing (CN); Hong Ji, Beijing (CN)

(73) Assignee: Xiaomi Inc., Beijing (CN)

(21) Appl. No.: 15/099,287

(22) Filed: Apr. 14, 2016

(30) Foreign Application Priority Data
Apr. 29, 2015 (CN) 201510213472.X

(51) Int. Cl. G06F 17/30

(52) U.S. Cl. CPC G06F 17/30528; G06F 17/3051; G06F 17/30867; G06F 17/3087

(57) ABSTRACT

Methods, apparatus and storage medium are disclosed for obtaining and rendering adaptive information in accordance with a current living setting of a user of a smart device. In one embodiment, the smart device monitors and detects triggering information for a scheduled event. When the event is triggered, the smart device queries a mapping between various triggering information and a plurality of living settings of the user of the smart device. Each living setting corresponds to a set of adaptive information tailored to that particular living setting. The smart device then determines the living setting based on the query, and then obtains and renders the corresponding set of adaptive information automatically.

### CROSS-REFERENCE TO RELATED APPLICATIONS

The application claims the benefit of priority to Chinese Patent Application No. 201510213472.X, filed Apr. 29, 2015, which is incorporated herein in its entirety for reference.

### TECHNICAL FIELD

The disclosure relates to smart devices and information technologies, and particularly relates to methods, devices and storage media for automatically obtaining and rendering adaptive information.

### BACKGROUND

Users of smart devices and the Internet may need to access a set of information from various information sources in different living settings. Living settings may be differentiated by time, date, and location. The set of information may need to be adapted for each living settings. Obtaining information manually from various sources for a particular living setting is inefficient. It may be desirable for a smart device to automatically determine a current living setting for a user, obtain and render the corresponding set of adaptive information.

### SUMMARY

The embodiments of the disclosure provide methods, devices and storage media for obtaining and rendering a set of adaptive information based on a user's current living setting.

In accordance with a first embodiment, a method for obtaining and rendering adaptive information is provided for a smart device, such as a mobile phone, a smart TV, and smart audio equipment. The method comprises determining by the device whether a scheduled event is triggered by automatically monitoring a triggering information; automatically selecting a current living setting for the user based on the triggering information from a plurality of living settings when the scheduled event is triggered; automatically obtaining a set of adaptive information corresponding to the selected living setting; and rendering the set of adaptive information in the device.

According to a second embodiment, a smart device for obtaining and rendering adaptive information is provided. The smart device comprises a memory having codes stored therein; and one or more processors, when executing the codes, configured to: determine whether a scheduled event is triggered by automatically monitoring a triggering information; automatically select a current living setting for the user based on the triggering information from a plurality of living settings when the scheduled event is triggered; automatically obtain a set of adaptive information corresponding to the selected living setting; and render the set of adaptive information in the device.

According to a third embodiment, a non-transitory computer-readable storage medium is provided, the medium having stored therein instructions that, when executed by a processor of a computing device, causes the computing device to perform the method of the first embodiment.

### BRIEF DESCRIPTION OF THE DRAWINGS

The devices, systems and methods of this disclosure may be better understood with reference to the following drawings and description. Non-limiting and non-exhaustive embodiments are described with reference to the following drawings. The components in the drawings are not necessarily to scale. Emphasis instead is placed upon illustrating the principles of the invention. In the drawings, like referenced numerals designate corresponding parts throughout the different views.

FIG. 1 illustrates a flowchart of a method for automatically obtaining and rendering a set of adaptive information in accordance a current living setting of a user;

FIG. 2 illustrates a flowchart of another method for obtaining and rendering a set of adaptive information in accordance with a current living setting of a user;

FIG. 3 illustrates a flowchart of yet another method for obtaining and rendering a set of adaptive information in accordance with a current living setting of a user;

FIG. 4 illustrates a flowchart for automatic status switching of a smart device.

FIG. 5-8 illustrate block diagrams of a device for obtaining and rendering a set of adaptive information in accordance with a current living setting of a user;

FIG. 9 illustrates another block diagram of a device for obtaining and rendering a set of adaptive information in accordance with a current living setting of a user.

### DETAILED DESCRIPTION

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

The methods, devices, and modules described herein may be implemented in many different ways and as hardware, software or in different combinations of hardware and software. For example, all or parts of the implementations may be a processing circuitry that includes an instruction processor, such as a central processing unit (CPU), microcontroller, a microprocessor; or application specific integrated circuits (ASICs), digital signal processors (DSPs), digital signal processing devices (DSPDs), programmable logic devices (PLDs), field programmable gate arrays (FPGAs), controllers, micro-controllers, microprocessors, other electronic components; or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Subject matter will now be described in more detail hereinafter with reference to the accompanying drawings. The drawings form a part hereof, and show, by way of illustration, specific exemplary embodiments. Subject matter may, however, be embodied in a variety of different forms and, therefore, covered or claimed subject matter is intended to be construed as not being limited to any exemplary embodiments set forth herein. A reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The technical description of this disclosure provides solutions to automatically and adaptively obtaining information by a smart device for a user based on a varying living setting of the user. A living setting generally characterizes a particular environment that the smart device and/or the user are in. A plurality of living settings may be defined based on date, time, location, and other factors. For example, 8am of a holiday at home may be defined as one living setting; 6 pm of a workday at home may be defined as another living setting. Each living setting may correspond to a set of particular information that the user may be interested in knowing, viewing, or listening in that particular living setting. A user's living settings may change in time and/or location. A user thus may be in any one of a plurality of living settings each corresponding to a set of adaptive information that may be of interest. For example, if the particular time and location is a workday morning at home, then it may be desirable for the user to be informed of the outside weather, some particular morning news items, and the local traffic condition from home to the user's workspace. The smart device may automatically acquire the set of adaptive information corresponding to any particular living setting from the networks once the smart device determines that the particular setting (e.g., time and/or location condition) is present. The set of adaptive information is eventually rendered by the smart device to the user. The set of adaptive information may be from a combination of various sources. For example, some information within the set of adaptive information may be downloaded from a website while some other information within the set of adaptive information may be from a broadcasting source such as a TV station, a radio station, or an Internet broadcasting source. By this means, the user need not search for the set of information manually and adaptive sets of information may be automatically rendered to the user as the user goes from one living setting to another. The term “render” may be applied to various types of contents including but not limited to images, videos, audios, and websites.

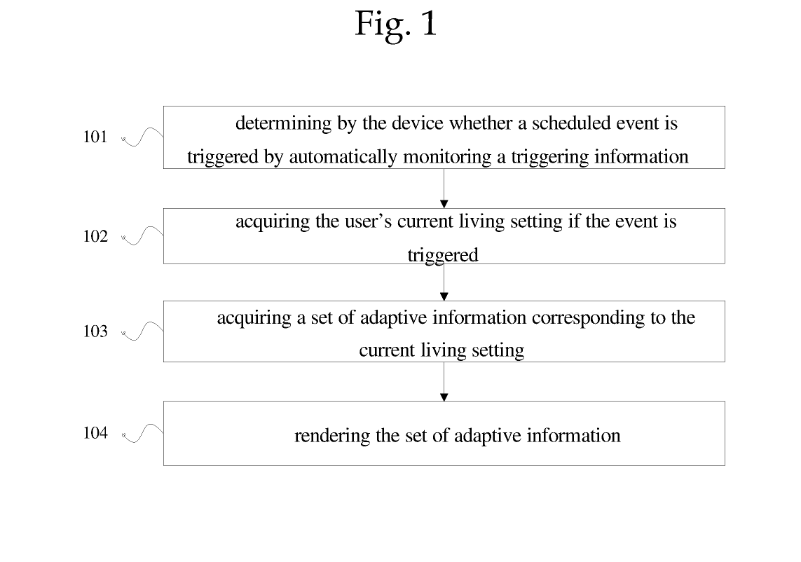

A method for obtaining a set of adaptive information is provided in an exemplary embodiment below. The method may be implemented in systems and devices including but not limited to smart devices such as mobile phones, smart TVs, and smart audio equipment. The flow chart in FIG. 1 illustrates this exemplary embodiment, which includes:

step 101 for determining by the device whether a scheduled event is triggered by automatically monitoring a triggering information;

step 102 for acquiring the user's current living setting if the event is triggered;

step 103 for acquiring a set of adaptive information corresponding to the current living setting; and

step 104 for rendering the set of adaptive information.

In this embodiment, the current living setting is acquired. The set of adaptive information corresponding to the current living setting is obtained and eventually rendered. Therefore, the adaptive information corresponding to the current living setting can be acquired and rendered to the user automatically without manual searching by the user. Efficiency in obtaining desired and tailored information for the user may therefore be improved. In the embodiment above and related embodiments below, the smart device performs rendering of information triggered by a scheduled event that is monitored and detected by the smart device itself.

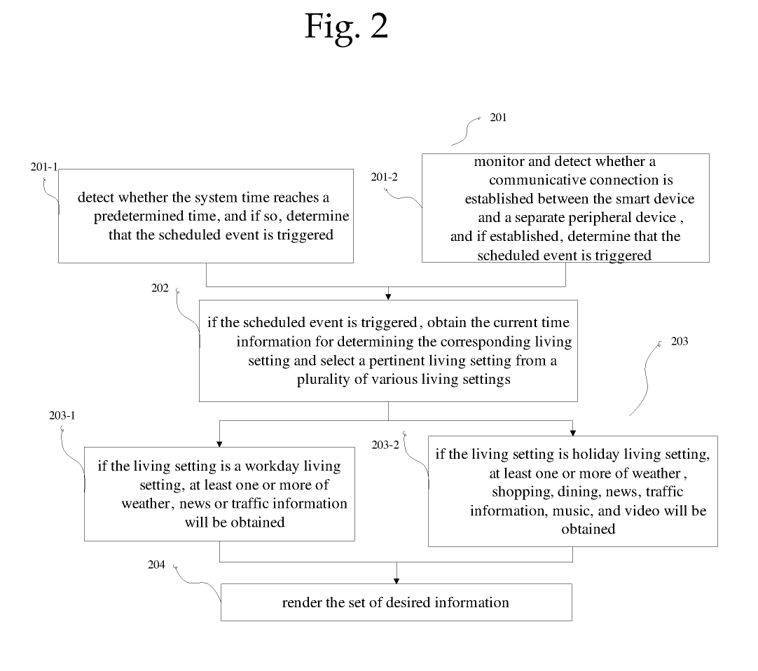

Referring to FIG. 2, a method for acquiring a set of adaptive information is provided in another exemplary embodiment for implementation in smart devices such as mobile phones, smart TVs, and smart audio equipment. In step 201, the smart device determines whether a scheduled event is triggered. There may be at least two alternatives to determining that a scheduled event is triggered.

In the first alternative, shown by step 201-1, the smart device determines that the scheduled event is triggered when it detects a system time that reaches a predetermined time. Each of a plurality of predetermined times may correspondingly be mapped to one of a plurality of predefined living settings. The mapping may be stored in the smart device. Thus, the scheduled event is triggered if the system time reaches the predetermined time corresponding to the predefined living setting. An event corresponds function call in the device. The predetermined time may be of various forms. For example, the predetermined time may be a particular time of a particular day. The scheduled event may be triggered directly if the smart device detects that the predetermined time and date is reached. The smart device may query its system time and its system calendar to obtain the current time and date, and compare them with the predetermined time and date. If there is a match, the scheduled event will be triggered. Alternatively, the predetermine time may be specified in the form of certain day type. For example, the predetermined time may be set as either a workday or a holiday. The smart device would trigger the scheduled event if it determines that the current day is of the predetermined type. Those of ordinary skill in the art understand that the predetermined time may be a hybrid of the two alternative forms above. For example, the predetermined time may be set as noon of a workday and the smart device would trigger, for example, when the system time reaches 12pm of a workday by checking the current time and the type of day for the current day in its calendar. More sophisticated forms of predetermined time for triggering the scheduled event may be constructed based on the principles descried above.

In the second alternative to determining whether a scheduled event is triggered, shown by step 201-2, the triggering may be based on some other condition rather than date. For example, the smart device may monitor and detect whether a communicative connection is established between the smart device and a separate peripheral device such as a smart plug-in device or a smart wearable equipment. If such a connection is determined by the smart device to be established, the scheduled event is then triggered. By this way, when a user wearing a smart wearable equipment approaches the smart device, a communicative connection may be established between the smart device and the smart wearable equipment, and the scheduled event may be triggered when the smart device detects the communicative connection. The communicative connection may be of any suitable form, such as Bluetooth or Wi-Fi (Wireless-Fidelity) connection. The setup credentials needed for these connections may be pre-established. The smart device and the smart wearable equipment are then paired in a predefined way of communication. Once paired, they may keep the identification of each other for setting up the connection between them automatically when they are within their range of communication.

Once the scheduled event is triggered, the smart device, in step 202, may obtain the current time information for determining the corresponding living setting. The smart device may select a pertinent living setting from a plurality of various living settings. These living settings may be stored locally on the smart device. They may alternatively be stored remotely in, for example, a user account or device account in the cloud.

A user may prefer different sets of adaptive information for different living settings. For example, a user's information preference in a workday is typically different from that of a holiday. Therefore, the type of day of the current day may be determined firstly before the living setting is determined. For example, if the current day is workday, the pertinent living setting may correspond to a set of adaptive information that includes the current weather, news items of the day, and traffic information (such as the traffic between the user's home and workplace). However, if the current day is a holiday, the pertinent living setting may corresponds to a set of adaptive information that includes local shopping and dining information in addition to weather and news. Thus, the current time information may include the date, where the date may be classified as a workday or a holiday. Accordingly, the plurality of living settings may include a workday living setting and a holiday living setting.

It is preferable that the smart device acquire the date information automatically without manual input from the user. For example, the smart device may keep track of current time information including current date and type of date in the smart device itself. Alternatively, the smart device may automatically acquire current date and type of date information periodically from a cloud server via suitable networks.

Furthermore, the living setting of the user may also be different at different time of a particularly day. For example, if the date is workday, and the time is 8 am, it may be the user's desire to obtain weather, news and traffic information from home to workplace. But if the date is workday, and the time is 6 pm, it may be the user's desire to access news and traffic information from workplace to home rather than from home to workplace. Thus, the work day living setting and holiday living setting discussed above may be further refined to a more expansive group of different living settings according to the additional factor of the time of the day:

if the time is between 7:30 am and 8:30 am in a workday, it would be a workday getting-up living setting;

if the time is between 17:30 pm and 19:30 pm in a workday, it would be a workday dinner living setting;

if the time is between 19:30 pm and 24:00 pm in a workday, it would be a workday rest living setting;

if the time is between 8:00 am and 9:00 am in a holiday, it would be a holiday getting-up living setting;

if the time is between 9:00 am and 12:00 am in a holiday, it would be a holiday leisure living setting ;

if the time is between 12:00 am and 13:00 pm in a holiday, it would be a holiday lunch living setting ;

if the time is between 13:00 pm and 17:00 pm in a holiday, it would again be a holiday leisure living setting;

if the time is between 17:00 pm and 19:00 pm in a holiday, it would be a holiday dinner living setting;

if the time is between 19:00 pm and 24:00 pm in a holiday, it would be a holiday rest living setting.

Furthermore, classification of living settings may be dependent on location of the device in addition to current time and date. This is because the set of adaptive information of interest to the user in one location may be different for another location even on the day and at the time. Thus, the examples of living settings listed above may be further refined to include location information. Alternatively, the location information may be utilized as described later in the embodiment of FIG. 2.

In step 203, the smart device acquires the set of adaptive information corresponding to the living setting determined in step 202 based on time, date, and location information. If the plurality of living settings is not refined to include location formation, the location information may now be combined with the living setting in obtaining the set of adaptive information in step 203.

The location of the smart device may be determined by a positioning module of the smart device. The positioning module may be based on GPS technology. It may alternatively be based on other technologies such as Wi-Fi positioning, cellular positioning technology, or a combination thereof. Alternatively, a procedure for the smart device to obtain location information may be executed when initializing the smart device. The smart device may further refine the location information for better precision during step 203 even though some location information is obtained by the smart device during initialization. The smart device may select a living setting from a plurality of living settings based on time, date and location information determined by its positioning module and may send a request for a set of adaptive information corresponding to the selected living setting.

The smart device may alternatively select a living setting from a plurality of refined living settings based only on time and date and then send a request for a set of adaptive information. In that case, the request may carry the location information in addition to but separately from identifying the corresponding living setting. Alternatively for this case, the request for obtaining the set of adaptive information sent to the cloud by the smart device may carry, in addition to identifying the selected set of living setting, the IP address of the smart device rather than location information. As an alternative to IP address of the smart device, the request for a set of adaptive information may carry the user's ID or the ID of the smart device. The location information corresponding to the user ID or the device ID may be predetermined and stored in the server (particularly for devices that are non-mobile, such as smart TVs and smart home audio equipment). The cloud server may determine a rough location according to the IP address. The cloud server may alternatively look up the pre-stored location of the smart device according to the user ID, or the ID of the smart device included in the request. The cloud server may then obtain a set of adaptive information according to the living setting in addition to the location information.

Each set of the sets of adaptive information in the embodiments of the disclosure may include, but are not limited to, weather, news, traffic, shopping, dining information, music, and video content. Accordingly, exemplary set of adaptive information corresponding to a living setting in step 203 may be:

if the living setting is a workday living setting, at least one or more of weather, news or traffic information;

if the living setting is holiday living setting, at least one or more of weather, shopping, dining, news, traffic information, music, and video.

Accordingly, step 203 may be executed by the following alternative steps:

in step 203-1, if the living setting is a workday living setting, at least one or more of weather, news or traffic information will be obtained;

in step 203-2, if the living setting is holiday living setting, at least one or more of weather, shopping, dining, news, traffic information, music, and video will be obtained.

Various approaches may be used to obtain the set of adaptive information. Some exemplary approaches will be described in more detail below. The set of adaptive information in accordance with each living setting may be specified in the smart device in advance by user preference, and the types of various information within the selected set of adaptive information may be specified in the request. Alternatively, the smart device may only send the living setting information (with or without location information as described above) to the cloud and the cloud subsequently determines the set of adaptive information based on a mapping between living settings and sets of information stored in advance in the cloud server. The cloud server determines and obtains from various sources the set of adaptive information according to the living setting information included in the request. Alternatively, the smart device may keep a portion of the set of adaptive information in itself. For example, if the living setting is a workday getting-up living setting, the corresponding set of adaptive information may include setting the audio content of an alarm clock residing on the smart device.

The cloud server may determine the set of adaptive information corresponding to the location information in addition to the living setting. As described previously, the location information may be determined and sent by the smart device with the request for adaptive information. Alternatively, if the request for a set of adaptive information further carries the IP address of the smart device, the cloud server may estimate the location information based on the IP address. If the request for a set of adaptive information carries the user's ID, or the ID of the smart device, the cloud server may query the pre-stored mapping between the location information and user's IDs or the smart device IDs. The cloud server may then obtain information pertinent to the location, such as traffic information, as a part of the set of adaptive information.

In the embodiments above, if the smart device is audio equipment, the cloud server may ensure that the acquired set of adaptive information is audio by checking the ID of the smart device carried in the request. The cloud server may acquire the set of adaptive information involves traffic, weather, news and the like in voice or convert the information into voice.

The users may define the types of information by themselves according to their actual need in advance. Those preferences may be stored in the cloud server according to user IDs and device IDs. By obtaining the user's ID or the ID of the smart device carried in the request, the cloud server may determine the types of user-defined information in the set of adaptive information according to the living setting and acquire the corresponding set of adaptive information from various information sources. The information sources may, for example, be content on various web servers on the internet.

In step 204, the smart device renders the set of desired information. Specifically, if the smart device is a smart TV, the set of adaptive information may be shown in a designated area on the screen of the smart TV while playing TV shows or other video. In one embodiment, each piece of information within the set of adaptive information may be shown in time sequence: each piece of information may be shown for a predetermined time before showing the next piece of information within the set of adaptive information. If the smart device is audio equipment, the set of adaptive information may be audio which will be decoded and played by the audio equipment.

The working of the embodiment of FIG. 2 may be illustrated by the exemplary implementation scenario below. Assume the current day is a workday, the current time is 7:30 am, and the predetermined trigger time is 7:30 am in workdays. The smart TV detects that a scheduled event is triggered according to the system time, and determines that the current living setting is workday getting-up living setting according to the current time and date. After that, the smart TV obtains the set of adaptive information corresponding to workday getting-up living setting, e.g., an audio stream for waking up the user. The smart TV then plays the audio to remind the user that it is time to get up.

In the exemplary implementation above and other implementations, the current living setting is acquired by detecting whether the predetermined time is reached or whether the communication connection with the smart wearable equipment is established. After that, a set of adaptive information corresponding to the living setting is obtained and eventually rendered. In this way, the smart TV obtains the corresponding set of adaptive information according to the living setting and renders the obtained information to the user automatically. The user needs not to search for the information manually which enhances the efficiency and speed for the user to adaptively access a desired set of information tailored to a particular living setting.

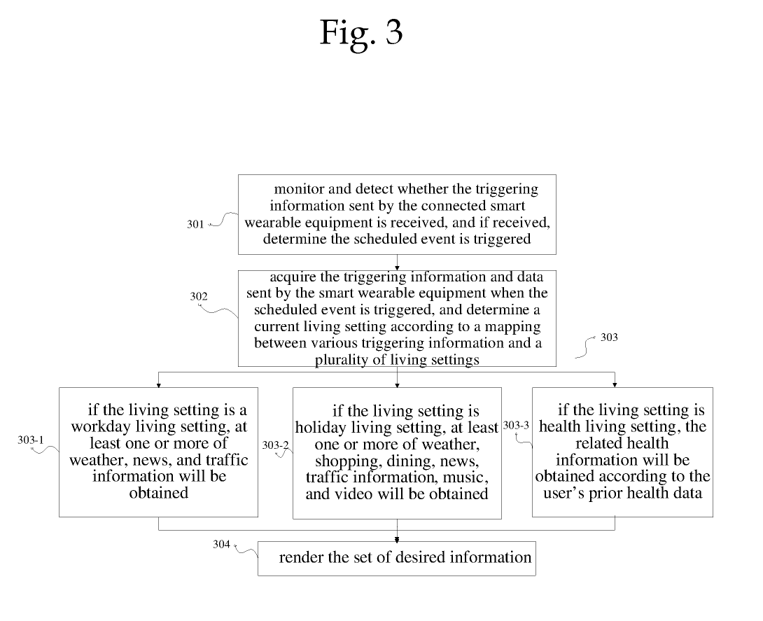

Referring to FIG. 3, another method for rendering a set of adaptive information is provided. The method may be implemented in smart devices such as mobile phones, smart TVs, and smart audio equipment. The smart device renders the set of adaptive information upon the trigger of a scheduled event via the triggering information sent by a smart wearable equipment.

In step 301, the smart device monitors and detects whether the triggering information sent by the connected smart wearable equipment is received by the smart device. If so, the scheduled event is triggered.

The triggering information sent by the smart wearable equipment may include, but is not limited to one of sleeping data, sports data, dinning data, health data, and so on. For example, the smart wearable equipment may detect and record sleeping data of the user wearing the wearable equipment. Those of ordinary skill in the art understand that the smart wearable equipment may be installed with various sensors and circuits for the detection and recording of sleeping data. The smart wearable equipment may further determine the awakeness state of the user according to the sleeping data. The awakeness state may be one of light sleeping state, deep sleeping state, and waking-up state. The smart wearable equipment may also detect dinning activities of the user and sent information indicating that the user is dinning. Similarly, the smart wearable equipment may be installed with sensors for detecting sporting data related to, for example, running, jogging, and weight lifting. The smart wearable equipment may send information containing the sporting status of the user. In addition, the smart wearable equipment may sense health related data, such as blood pressure and body temperature of the user and may send information that indicates the wellness status of the user.

In step 302, the smart device acquires the triggering information and data sent by the smart wearable equipment when the scheduled event is triggered, and determines a current living setting according to a mapping between various triggering information and a plurality of living settings. For example, the user's current health status may be determined via the various data in the triggering information sent from the smart wearable equipment, and a corresponding living setting suitable for the health status may be selected from a set of living settings. The set of living settings may be constructed to cover a wide range of possible living and working scenarios that a user may encounter.

The corresponding mapping between the triggering information and living settings may include, but not limited to the following exemplary scenarios:

If the triggering information is sleep data and the awakeness state is waking-up state, the corresponding living setting may be a getting-up living setting;

if the triggering information is sports data, the corresponding living setting may be a sporting living setting;

if the triggering information is dinning data indicating that the user is eating, the corresponding living setting may be a dinning living setting.

If the triggering information is health data indicating that the user may be interested in health information, the corresponding living setting may be health living setting.

Additionally and similar to previous description of the embodiment in FIG. 2, the living settings may be further refined to sub categories according to the current date. For example, if the current day is a workday, the getting-up living setting may be refined to a workday getting-up living setting whereas if the current day is a holiday, the getting-up living setting may be refined to holiday getting-up living setting. Similarly, a sporting living setting may be refined to a workday sporting living setting and a holiday sporting living setting.

In step 303, the smart device acquires the set of desired information in accordance with the living setting determined in step 302. Each set of the sets of adaptive information in the embodiment above may include, but is not limited to, weather, news, traffic, shopping, dining information, health information, music, and video content. Thus, step 303 may be executed in the following exemplary alternatives:

in step 303-1, if the living setting is a workday living setting, at least one or more of weather, news, and traffic information will be obtained;

in step 303-2, if the living setting is holiday living setting, at least one or more of weather, shopping, dining, news, traffic information, music, and video will be obtained; and

in step 303-3, if the living setting is health living setting, the related health information will be obtained according to the user's prior health data.

As explained previously, the living setting and corresponding set of adaptive information may additional be dependent on location of the smart device. Specifically, since the user may be at different location, it is desired to determine the set of adaptive information taking into consideration the location of the smart device. The location information may be incorporated in the construction of a refined plurality of living settings. For example, a workday getting-up living setting may be refined to workday getting-up living setting at home and workday getting-up living setting in a hotel. If the living setting is determined in step 302 without location information, location information may be combined with the living setting in the request for obtaining the set of adaptive information in step 303.

The location of the smart device may be determined by a positioning module of the smart device. The location module may be based on GPS technology. It may alternatively be based on other technologies such as Wi-Fi positioning, cellular positioning technology, or a combination thereof. Alternatively, the procedure for the smart device to obtain location information may be executed when initializing the smart device. The smart device may further refine the location information for better precision during step 303 even though some location information is obtained by the smart device during initialization. The smart device may select a living setting from a plurality of living settings based on time, date and location information determined by its positioning module and may send a request for a set of adaptive information corresponding to the selected living setting.

The smart device may alternatively select a living setting from a plurality of refined living settings based only on time and date and then send a request for a set of adaptive information. In that case, the request may carry the location information in addition to but separately from identifying the corresponding living setting. Alternatively for this case, the request for obtaining the set of adaptive information sent to the cloud by the smart device may carry, in addition to identifying the selected set of living setting, the IP address of the smart device rather than location information. As an alternative to IP address of the smart device, the request for a set of adaptive information may carry the user's ID or the ID of the smart device. The location information corresponding to the user ID or device ID may be predetermined and stored in the server (particularly for devices that are non-mobile, such as smart TVs and smart home audio equipment). The cloud server may determine a rough location according to the IP address. The cloud server may alternatively look up the pre-stored location of the smart device according to the user ID, or the ID of the smart device included in the request. The cloud server may then obtain a set of adaptive information according to the living setting in addition to the location information.

Various approaches may be used to obtain the set of adaptive information. The set of adaptive information in accordance with each living setting may be specified in the smart device in advance by user preference, and the types of various information within the selected set of adaptive information may be specified in the request. Alternatively, the smart device may only send the living setting information (with or without location information as described above) to the cloud and the cloud subsequently determines the set of adaptive information based on a mapping between living settings and sets of information stored in advance in the cloud server. The cloud server determines and obtains from various sources the set of adaptive information according to the living setting information included in the request.

The cloud server may determine the set of adaptive information corresponding to the location information in addition to the living setting. As described previously, the location information may be determined and sent by the smart device with the request for adaptive information. Alternatively, if the request for a set of adaptive information further carries the IP address of the smart device, the cloud server may estimate the location information based on the IP address. If the request for a set of adaptive information carries the user's ID, or the ID of the smart device, the cloud server may query the pre-stored mapping between the location information and user's IDs or the smart device IDs. The cloud server may then obtain information pertinent to the location, such as traffic information, as a part of the set of adaptive information.

In the embodiments above, if the smart device is audio equipment, the cloud server may make sure that the acquired set of adaptive information is audio by checking the ID of the smart device carried in the request. The cloud server may acquire the set of adaptive information involves traffic, weather, news and the like in voice or convert the information into voice.

The users may define the types of information by themselves according to their actual need in advance. Those preferences may be stored in the cloud server according to user IDs and device IDs. By obtaining the user's ID or the ID of the smart device carried in the request, the cloud server may determine the types of user-defined information in the set of adaptive information according to the living setting and acquire the corresponding set of adaptive information.

In step 304, the smart device renders the set of desired information. Specifically, if the smart device is a smart TV, the set of adaptive information may be shown in a designated area on the screen of the smart TV while playing TV shows or other video. In one embodiment, each piece of information within the set of adaptive information may be shown in time sequence: each piece of information may be shown for a predetermined time before showing the next piece of information within the set of adaptive information. If the smart device is audio equipment, the set of adaptive information may be audio which will be decoded and played by the audio equipment.

The working of the embodiment of FIG. 3 is illustrated by the exemplary implementation scenario below. Assume that the current date is workday, and the time is 7:30 am. The smart wearable equipment finds that the user has woken up according to the detected sleep data, and sends the sleep data to the smart TV as triggering information. The scheduled event is then triggered by the smart TV, which determines that the current living setting is a workday getting-up living setting according to the triggering information. After that, the information corresponding to the workday getting-up living setting, such as news, weather, and traffic information, will be acquired and rendered on the screen of the smart TV.

When the user is bodybuilding on the fitness equipment, the smart wearable equipment detects the sporting information and sends it to the smart TV as the triggering information. The smart TV then triggers the scheduled event, and determines the current living setting to be a sports and health living setting. After that, a set of adaptive information related to sports or bodybuilding, such as the user's current and historical exercise and health information, is acquired and rendered on the screen of the smart TV.

In the exemplary implementation above, the current living setting is acquired by detecting whether the predetermined time is reached or whether the communication connection with the smart wearable equipment is established. After that, a set of adaptive information corresponding to the living setting is obtained and eventually rendered. In this way, the smart TV obtains the corresponding set of adaptive information according to the living setting and renders the obtained information to the user automatically. The user needs not to search for the information manually. Efficiency and usability is thus enhanced for the user to adaptively access desired set of information.

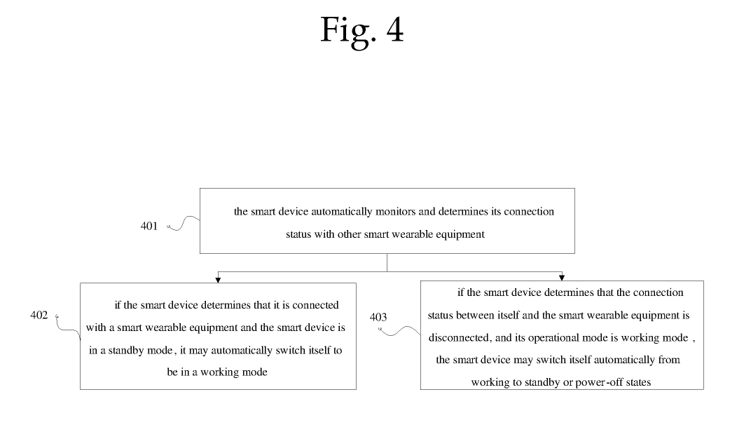

Referring to FIG. 4, a method for rendering information and operation mode switching is provided in another exemplary embodiment. The smart device may be in various operational modes including but not limited a working mode, a standby mode, and a power-off mode. The smart device may monitor its mode and switch between them automatically according to its connection status with other smart wearable equipment. The method may be implemented in smart devices including but not limited to mobile phones, smart TVs, and smart audio equipment.

In step 401, the smart device automatically monitors and determines its connection status with other smart wearable equipment. In step 402, if the smart device determines that it is connected with a smart wearable equipment and the smart device is in a standby mode, it may automatically switch itself to be in a working mode. For example, the user may wear a smart bracelet. The user may further keep a smart device, such as a smart TV in his house. The user may initially be outside the house and the smart TV may be in a standby mode. When the user enters the house, the smart bracelet may accordingly move into the connection range with the smart TV or other smart devices either directly or through a home network appliance. The connection between the smart bracelet and the smart TV or other smart devices may be based on direct wireless connection such as Bluetooth or Wi-Fi connection. It may alternatively be based on indirect connection via a home network appliance based on various suitable wireless technologies. The smart TV may automatically monitor and detect the connection. Alternatively, the smart bracket may request connection with the smart TV upon entering the network range. Once the connection is detected by the smart device or the request for connection is received by the smart device, the smart device may switch its mode to working mode and the connection with the smart bracelet is then established. Alternatively, the smart device may establish connection with the smart bracelet before switching its mode from standby to working.

In step 403, if the smart device determines that the connection status between itself and the smart wearable equipment is disconnected, and its operational mode is working mode, the smart device may switch itself automatically from working to standby or power-off states. For example, a user wearing a smart bracelet may initially be adjacent to a smart TV. The smart bracelet and the smart TV are connected either directly or via a home network appliance. When the user exits the house, the smart bracelet may move out of the range of network connection with the smart TV and may accordingly be disconnected from the smart TV or the home network appliance. The smart TV, in its working mode, may detect the loss of connection with the smart bracelet. The smart TV may then switch its mode from working to standby or power-off.

In the embodiment discussed above, the mode of the smart device is automatically controlled by monitoring and detecting the connection status between the smart device and other smart wearable equipment. The user needs not interfere with the control manually. The efficiency for controlling the smart device is thus enhanced.

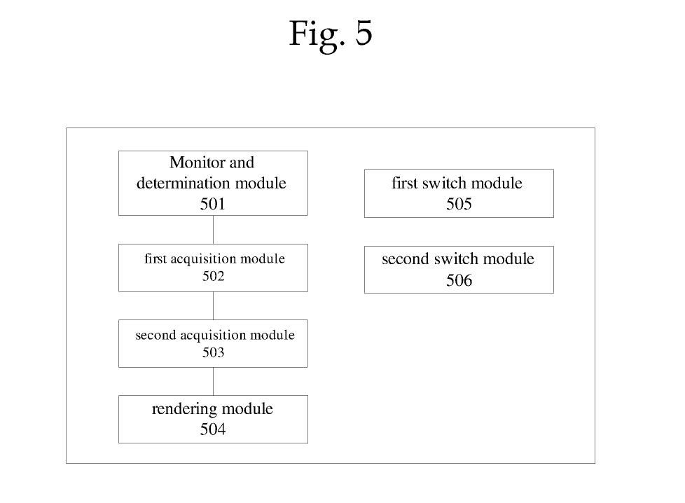

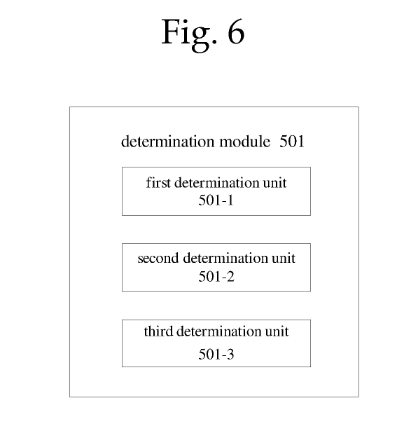

FIG. 5 shows an embodiment of a smart device for rendering adaptive information in accordance with the methods described in the exemplary embodiments described above. The smart device of FIG. 5 may be implemented as a mobile phone, a tablet, a PDA, a smart TV, or audio equipment. The device includes a monitor and determination module 501 for monitoring and determining whether a scheduled event is triggered. The monitor and determination module 501 may further include a first determination unit 501-1 for detecting whether the system time reaches a predetermined time; a second determination unit 501-2 for detecting whether a communication connection is established with a smart wearable equipment; and a third determination unit 501-3 for detecting whether a triggering information sent by the connected smart wearable equipment is received by the smart device, as illustrated in FIG. 6. If determination of either of unit 501-1, 501-2, and 501-3 is positive, the smart device determines that the scheduled event is triggered.

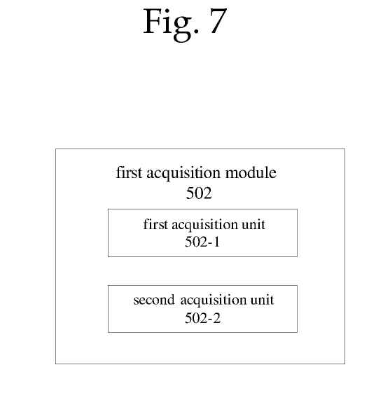

Back to FIG. 5, the smart device further includes a first acquisition module 502 for acquiring the user's current living setting when the scheduled event is triggered. As illustrated in FIG. 7, the first acquisition module 502 may further include a first acquisition unit 5021 for acquiring the current time, querying a mapping between the current time and a plurality of living settings, and obtaining the user's current living setting based on the querying; and a second acquisition unit 502-2 for acquiring triggering information sent by the connected smart wearable equipment, querying a mapping between the triggering information and the plurality of living settings, and obtaining the user's current living setting based on the querying.

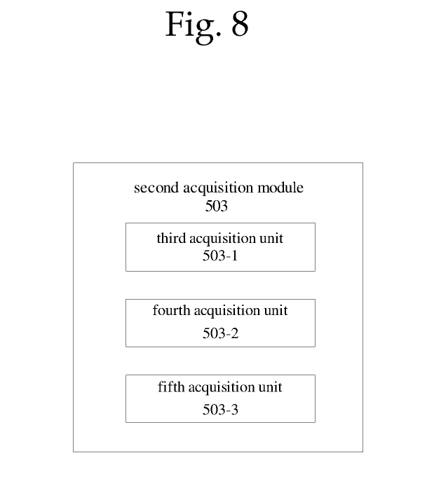

Back to FIG. 5 again, the smart device may also include a second acquisition module 503 for acquiring a set of adaptive information corresponding to the current living setting. FIG. 8 illustrates the components of the second acquisition module 503. Specifically, the second acquisition module 503 may include a third acquisition unit 503-1 for acquiring one or more of weather, news or traffic information if the current living setting is a workday living setting; a fourth acquisition unit 503-2 for acquiring one or more of weather, shopping, dining, news, traffic, music, and video information if the current living setting is a holiday living setting; and a fifth acquisition unit 503-3 for searching health information related to the user's prior health data if the current living setting is a health living setting.

FIG. 5 show that the smart device may additionally include a rendering module 504 for rendering the set of adaptive information. Furthermore, the smart device may include a first switch module 505 for switching the operating mode of the smart device to wording mode if it is connected to the smart wearable equipment and its status is on standby; and a second switch module 506 for switching the operating mode of the smart device to standby or power-off if it is disconnected to the smart wearable equipment and its mode is working.

In the smart device described in the embodiment above, the set of adaptive information corresponding to the current living setting of the user is acquired and rendered automatically. The user needs not search for the information manually, leading to enhanced efficiency for obtaining relevant information.

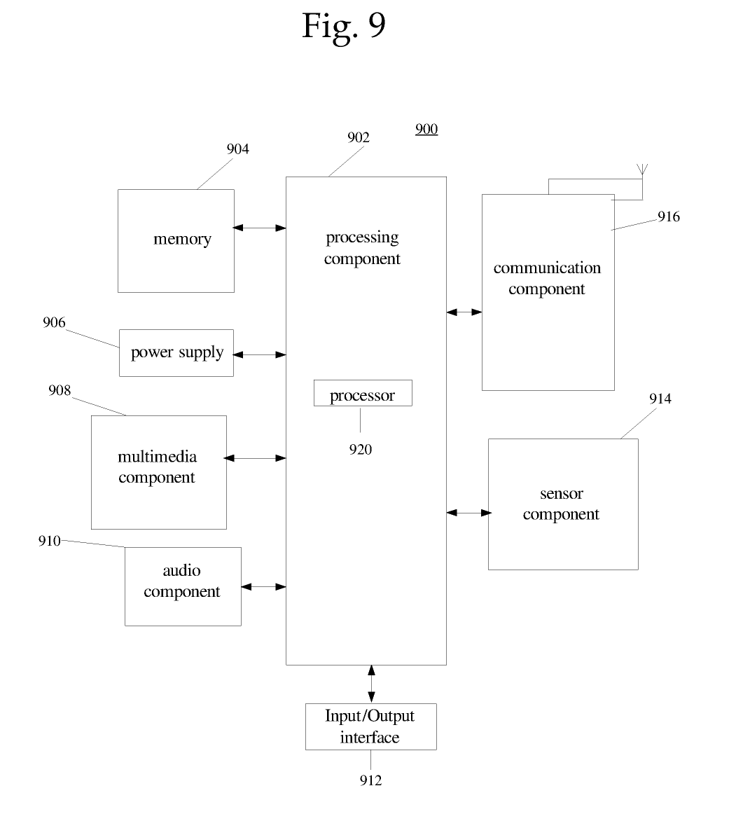

FIG. 9 shows in more detail an embodiment of a smart device, 900, for automatically obtaining and rendering information adaptive to a plurality of living settings of the user of the device. The smart device 900 may be one of but is not limited to a mobile phone, a tablet, a computer, a digital broadcasting terminal, a message transceiver, a game console, a tablet, a PDA, a smart TV, a medical equipment, and a bodybuilding equipment. The device 900 includes one or more of processing component 902, memory 904, power supply 906, multimedia component 908, audio component 910, input/output (I/O) interface 912, sensor component 914, and communication component 916.

The processing component 902 controls the operations of the device 900, such as the operations associated with display, telephone-call, data communication, and camera operation. The processing component 902 may include one or more processors 920 to execute instructions for performing some or all of the operations above.

The memory 904 is configured to store various types of data needed for the operations of the device 900. These data may include but are not limited to instructions for applications and the operating system, contacts, phonebook, messages, pictures, music, and videos. The memory 904 may be implemented by volatile media, non-volatile media, or the combinations thereof, such as static random access memory (SRAM), electrical erasable programmable read only memory (EEPROM), read only memory (ROM), magnetic memory, flash memory, magnetic disk, and optical disks.

The power supply 906 supplies necessary power to various components of the device 900. The power supply 906 may include a power management system, one or more power sources, and other components related to producing, managing and distributing power.

The multimedia component 908 includes a screen acting as an output interface between the device 900 and the user. In some embodiments, the screen may be liquid crystal display (LCD) or touch panel (TP). A touch screen may include various sensors for receiving user input in addition to displaying information. In some embodiments, the multimedia component 908 includes a front camera or a rear camera.

The audio component 910 is configured to output and/or input audio signal. For example, the audio component 910 may include a microphone (MIC). The audio component 910 may further include a speaker for outputting audio signal. I/O interface 912 is used to provide an interface between component 902 and peripheral equipment, including but not limited to keyboard, mouse, and other plug in devices. The sensor component 914 includes one or more sensors for monitoring the status of the device 900. For example, the sensor component 914 can detect the on/off mode of the device. The sensor component 914 may include sensors that is capable of detecting relative position of other components. For example, the sensors within the sensor component 914 may detect physical shifting between display and input pads of device 900. The sensor component 914 may further include sensors such as thermometers, accelerometers, magnetic sensors, pressure sensors, gyros, proximity sensors, and optical sensors such as CMOS or CCD image sensor for imaging.

The communication component 916 is configured to facilitate communication between the device 900 and other devices. The device 900 may access wireless network based on communication technologies, such as Wi-Fi and various generations of cellular communications. In an exemplary embodiment, the communication component 916 receives the set of adaptive information or related information from external information sources via communications channels. In another exemplary embodiment, the communication component 916 may further include nearfield communication (NFC) modules for short-range communication. For example, the NFC module may be implemented by radio frequency identification, infrared communication, ultra wideband, Bluetooth, or other technologies.

In the exemplary embodiments, the device 900 may be implemented by one or more of Application Specific Integrated Circuits (ASICs), digital signal processors(DSPs), digital signal processing device, programmable logic devices (PLDs), field programmable gate arrays(FPGAs), controllers, microcontrollers, microprocessors, and other electrical components to performing the operations described above.

In another exemplary embodiment, a non-transitory computer-readable storage medium with instructions stored thereon may further be provided. The instructions may be executed by the processor 920 of the device 900 to perform the methods described above. The non-transitory computer-readable store medium may include but is not limited to ROM, random access memory (RAM), CD-ROM, magnetic tape, floppy disk, flash memory, and optical data store.

Each module or unit discussed above for FIG. 5-8, such as the monitor and determination module, the first acquisition module, the second acquisition module, the rendering module, the first determination unit, the first and second determination units, the first, second, third, and fourth acquisition units, may take the form of a packaged functional hardware unit designed for use with other components, a portion of a program code (e.g., software or firmware) executable by the processor 920 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive. It should be appreciated that the invention is not limited to the precise structure described above and shown in the drawings, and various modifications and changes may be made within the scope of the disclosure. The scope of the invention is only limited by the appended claims.

What is claimed is:

1. A method for automatically obtaining adaptive information, comprising:
determining by a device whether a scheduled event is triggered by automatically monitoring triggering information; and
in response to determining that the scheduled event is triggered:
automatically selecting a current living setting for a user based on the triggering information from a plurality of living settings;
automatically obtaining a set of adaptive information corresponding to the selected living setting; and
rendering the set of adaptive information in the device.

2. The method of claim 1, wherein the triggering information comprises a system time maintained by the device or acquired from a server by the device, and wherein determining whether the scheduled event is triggered comprises obtaining the system time and determining when the system time reaches a predetermined time.

3. The method of claim 2, wherein automatically selecting the current living setting comprises:
querying a mapping between a plurality of times and the plurality of living settings using the system time; and
selecting the current living setting from the plurality of living settings according the querying.

4. The method of claim 2, wherein automatically selecting a current living setting based on the triggering information from a plurality of living settings comprises:
determining a current location of the device;
querying a mapping between a plurality of times and locations, and the plurality of living settings using the system time and the current location; and
selecting the current living setting from the plurality of living settings according the querying.

5. The method of claim 1, wherein determining by the device whether the scheduled event is triggered comprises:
monitoring by the device triggering information comprising a communicative connection status between the device and a wearable equipment; and
determining that the scheduled event is triggered when the triggering information indicates that a connection between the device and the wearable equipment is established.

6. The method of claim 5, wherein automatically selecting a current living setting based on the triggering information from a plurality of living settings comprises:
querying a mapping between a plurality of triggering information and the plurality of living settings using the triggering information; and
selecting the current living setting from the plurality of living settings according the querying.

7. The method of claim 5, further comprising:
automatically self-switching an operation mode of the device from standby mode to working mode when the device is in standby mode and the triggering information indicates that a connection between the device and the wearable equipment is established; and
automatically self-switching the operation mode of the device from working mode to standby mode when the device is in working mode and the triggering information indicates that a connection between the device and the wearable equipment is disconnected.

8. The method of claim 1, wherein determining by the device whether the scheduled event is triggered comprises:
monitoring by the device a triggering information sent by a wearable equipment connected to the device;
obtaining the triggering information; and
determining that the scheduled event is triggered when the triggering information is received by the device.

9. The method of claim 8, wherein automatically selecting a current living setting based on the triggering information from a plurality of living settings comprises:
querying a mapping between a plurality of triggering information and the plurality of living settings using the triggering information; and
selecting the current living setting from the plurality of living settings according the querying.

10. The method of claim 1, wherein the plurality of living settings are predefined by the user and comprise workday living setting, holiday living setting, and health maintenance living setting.

11. The method of claim 10, wherein automatically obtaining adaptive information corresponding to the selected living setting comprises:
automatically acquiring by the device adaptive information comprising one or more of weather, news, and traffic information when the selected living setting is workday living setting;
automatically acquiring by the device adaptive information comprising one or more of weather, shopping, dining, news, traffic information, music content, and video content information when the selected living setting is holiday living setting; and
automatically acquiring by the device adaptive information comprising at least one of the user's current or prior health data when the selected living setting is health maintenance living setting.

12. A device for automatically providing adaptive information, comprising:
a memory having codes stored therein; and
one or more processors, when executing the codes, configured to:
determine by the device whether a scheduled event is triggered by automatically monitoring a triggering information;
automatically select a current living setting for the user based on the triggering information from a plurality of living settings when the scheduled event is triggered;
automatically obtain a set of adaptive information corresponding to the selected living setting; and
render the set of adaptive information in the device.

13. The device of claim 12, wherein the one or more processors, in determining whether a scheduled event is triggered, are configured to:
monitor a triggering information comprising a communicative connection status between the device and a wearable equipment;
and determine that the scheduled event is triggered when the triggering information indicates that a connection between the device and the wearable equipment is established.

14. The device of claim 13, wherein the one or more processors, in selecting a current living setting based on the triggering information from a plurality of living settings, are configured to:
query a mapping between a plurality of triggering information and the plurality of living settings using the triggering information; and
select the current living setting from the plurality of living settings according the querying.

15. The device of claim 13, wherein the one or more processors, in executing the code, are further configured to:
self-switch the device from a standby mode to a work mode when the device is in the standby mode and the triggering information indicates that a connection between the device and the wearable equipment is established; and
self-switch the device from the work mode to the standby mode when the device is in the work mode and the triggering information indicates that the connection between the device and the wearable equipment is disconnected.

16. The device of claim 12, wherein the one or more processors, in determining whether a scheduled event is triggered, are configured to:
monitor by the device a triggering information sent by a wearable equipment connected to the device;
obtain the triggering information; and
determine that the scheduled event is triggered when the triggering information is received by the device.

17. The device of claim 16, wherein the one or more processors, in selecting a current living setting based on the triggering information from a plurality of living settings, are configured to:
query a mapping between a plurality of triggering information and the plurality of living settings using the triggering information; and
select the current living setting from the plurality of living settings according the querying

18. The device of claim 12, wherein the plurality of living settings are predefined by the user and comprise workday living setting, holiday living setting, and health maintenance living setting.

19. The device of claim 18, wherein the one or more processors, in obtaining adaptive information corresponding to the selected living setting living setting, are configured to:
acquire adaptive information comprising one or more of weather, news, and traffic information when the selected living setting is workday living setting;
acquire adaptive information comprising one or more of weather, shopping, dining, news, traffic information, music content, and video content information when the selected living setting is holiday living setting; and
acquire adaptive information comprising one or more of the user's current and prior health data when the selected living setting is health maintenance living setting.

20. A non-transitory computer-readable storage medium comprising instructions stored therein that, when executed by a processor of a computing device, causes the computing device to:
determine whether a scheduled event is triggered by automatically monitoring a triggering information;
in response to determining that the scheduled event is triggered:
automatically select a current living setting for a user based on the triggering information from a plurality of living settings when the scheduled event is triggered;
automatically obtain a set of adaptive information corresponding to the selected living setting; and
render the set of adaptive information in the device.
